(19) United States
(12) Patent Application Publication
(10) Pub. No.: US 2005/0228707 A1
(43) Pub. Date: Oct. 13, 2005

(54) Method for real-time allocation of customer service resources and opportunities for optimizing business and financial benefit

(76) Inventor: Robert Hendrickson, Bedminster, NJ (US)

Correspondence Address: KATTEN MUCHIN ROSENMAN LLP, 575 MADISON AVENUE, NEW YORK, NY, 10022-2585, US

(21) Appl. No.: 11/018,843

(22) Filed: Dec. 21, 2004

Related U.S. Application Data
(60) Provisional application No. 60/532,417, filed on Dec. 23, 2003.

(51) Int. Cl. G06F 17/60

(52) U.S. Cl. 705/8

(57) ABSTRACT

A method and systems architecture for allocating and adjusting service delivery resources in real-time on the basis of predicting associated financial profits and/or benefits to an organization. The method includes the steps of: a) determining service resource costs and characteristics, b) predicting service demand, c) setting service objectives are determined at step, d) determining a service capacity, e) setting associated service delivery rules, and f) allocating resources according to the business rules. Actual resource availability and service performance are monitored in real-time, and profitability of service performance is forecast based on real-time data and simulations. Results from profitability analysis are used to adjust predicted service demand, service objectives, service delivery rules and resource allocations in real-time.

### CROSS-REFERENCE TO RELATED APPLICATION

The present application claims priority under 35 U.S.C.§ 119(e) from U.S. Ser. No. 60/532,417, entitled “Method For Real-Time Allocation Of Customer Service Resources And Opportunities For Optimizing Business And Financial Benefit,” filed on Dec. 23, 2003. U.S. Ser. No. 60/532,417 was filed by an inventor common to the present application, and is hereby incorporated by reference.

### FIELD OF THE INVENTION

The present invention relates to a method for allocating service delivery resources in real-time in order to financially optimize associated profits and/or benefits to an organization. In particular, the invention relates to a method for real-time modeling and measuring of service delivery demand, capacity, opportunities and performance in order to provide for optimized real-time management and adjustment of service delivery.

### BACKGROUND OF THE INVENTION

Making efficient use of service delivery resources including service personnel in service industries is a key element of profitable business performance. These industries are often highly reliant on human labor, which tends to be costly in comparison for example to mechanized resources used in other industries. Accordingly, service managers look for opportunities to reduce the human labor content of their services, and for opportunities to better match service capabilities and costs to desired service deliveries. Especially for high-end service industries associated with luxury and other discretionary items, the availability and caliber of associated service personnel becomes an extremely important determinant with respect to profitability and opportunities for repeat business.

While it is known in the art to perform demand forecasting as a means for establishing staffing levels in accordance with desired service levels (see, e.g., U.S. Pat. No. 5,911,134 to Castonguay et al., which is hereby incorporated by reference), it would be desirable to extend these methods to establish service delivery resources, opportunities, standards and associated business rules, on the basis of forecasting profitability and business benefit of the delivered service. In addition, it would be desirable to account for random and non-random variation in service demand and resource availability in forecasting profitability of the delivered service, and to provide for the monitoring, measuring and control of service delivery executions, in real-time, in order to achieve a desired business profitability and other business benefits associated with established service standards and objectives.

### SUMMARY OF THE INVENTION

The present invention relates to a method and system architecture for allocating service delivery resources in order to achieve the highest profit. The number of resources that are needed and/or available to service a particular one or more spatial locations in which services are being rendered to customers are determined. Service delivery resources to be allocated include labor to provide services within each spatial location, as well other resources such as time, equipment, associated products, literature and materials to be provided to customers, customer goodwill, and the like.

Initially, the costs, characteristics and capabilities of each of the resources (for example, specific skill sets of service personnel) are determined. Based on this information, theoretical models are used for allocating resources within the spatial locations to provide the services needed in order to optimize the profit, by making use of the labor and other cost-bearing resources servicing customers within the each spatial location.

Thereafter, in real time, currently available resources and actual service demands are tracked. Evaluating the demand, available resources and opportunities for service delivery against a theoretical optimum, a real-time re-allocation of resources is performed to optimize the profit and other business benefits, according to the currently available resources. Variations between actual resource availability after allocation and predicted resource availability, and between actual service demands and predicted service demands, are tracked and used for fine-tuning the theoretical models for resource allocation over selected service periods, providing for the reallocation of resources during any stage of all service deliveries. Based on actual resource availability, associated skill sets and capabilities, and service demand, resources are reallocated and associated service priorities are re-defined.

### BRIEF DESCRIPTION OF THE DRAWINGS

A more complete understanding of the invention may be obtained by reading the following description of specific illustrative embodiments of the invention in conjunction with the appended drawing in which:

FIG. 1 provides a service management system architecture illustrating the principles of the present invention;

FIG. 2 further illustrates components of the service management system architecture of FIG. 1; and

FIG. 3 presents a flow diagram illustrating a series of steps associated with a method according to the present invention.

### DETAILED DESCRIPTION OF THE PREFERRED EMBODIMENT

The following scenario illustrates a typical service delivery event as is contemplated by the present invention.

A customer comes to a retail outlet, and is electronically recognized, for example, by swiping a card upon entry to the outlet, or by a variety of other known means for automated means for customer recognition. She is identified by an associated customer identification system as a potential high value customer who has shown increased purchase rates over the last 3 months.

Compared to other recognized customers in the outlet, she ranks as the highest potential purchase consumer in the outlet at that time, and accordingly, automatic personalized greetings and product offers are sent to a display device on a shopping cart she has obtained upon entering the outlet. With high sales value potential, a customer service representative is sent to greet her, and to offer to be her personal shopping assistant during this visit.

The customer declines, and the service representative notes such on a handheld computer, which gives her instructions to offer this consumer a 20% off coupon for any purchase in the shoe department good for the day of her visit only. The shoe department is selected because the customer has formerly purchased shoes and matching handbags, and because she earlier told the service representative she intended to visit to the hand bag department (the service representative entered this data into the handheld computer as they spoke). The offer is meant to cross sell shoes to the customer with the handbag, and to further incent her to make the handbag purchase.

The service representative is then dispatched to the next highest rated customer in the store at that time, and the process goes on. Other lower rated potential customers are not approached by the service representative, yet may receive specific offers to their shopping cart displays related to high inventory items the outlet would like to reduce or sell that morning in order to open up space for new products coming the following day, and related to purchases made by the customer in the past. A decision to offer 10% off of these items is made by a rules-based resource allocation optimization system as the most profitable execution available at that moment for that customer. Profitability is estimated based on prior customer purchases, customer potential value, and the value from moving old inventory out to open up space for new products coming in.

In this context, the present invention is described in further detail.

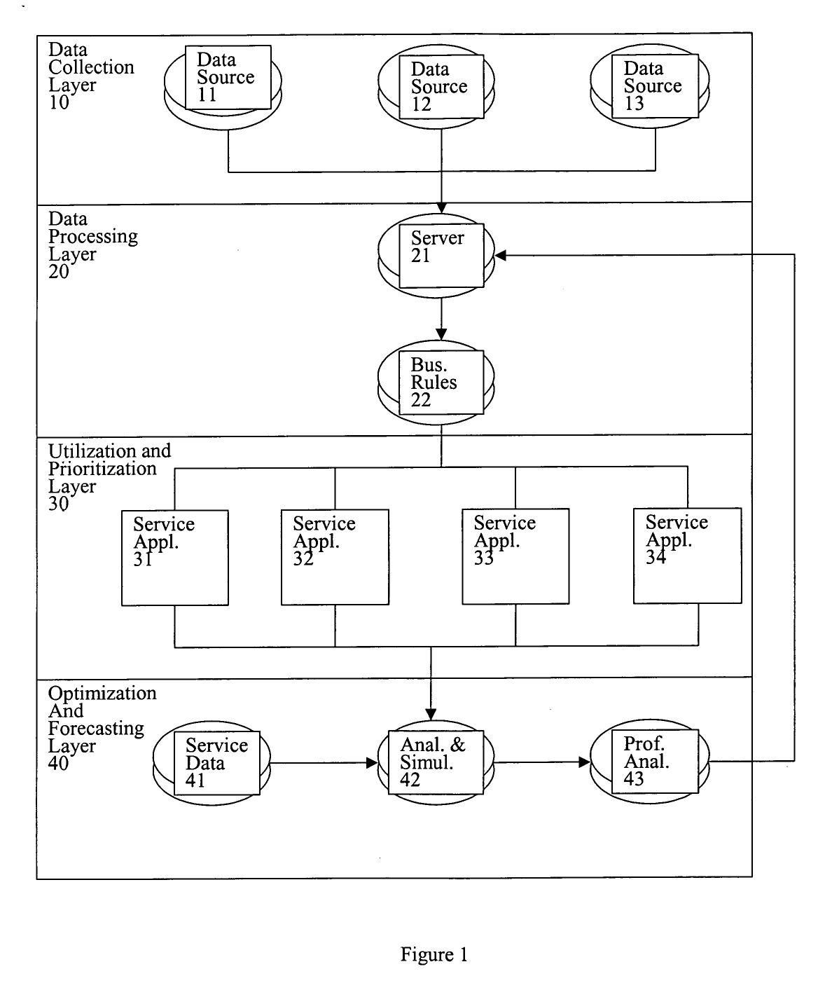

FIG. 1 presents a service management system architecture 1 according to principles of the present invention. It is envisioned that this architecture could be readily implemented by one skilled in the art using a conventional networked computing environment including one or more computers each having a processor, stored program control and storage (see, e.g., FIG. 1 of U.S. Patent Publication No. 20040087367, “Rules-Based Service Dispatch System For Gaming Devices”, which was filed on Oct. 31, 2002 and is hereby incorporated by reference).

The system architecture of FIG. 1 includes four component layers 10, 20, 30, 40. A data collection layer 10 includes data sources 11-13, which are configured to collect and retain key information relating to the managed service. For example, data sources 11-13 may include information relating to cost of resources for delivering services, historical service demand, current resource capacity, measures of historical service delivery performance, and the like.

In a data processing layer 20, a server operates on information supplied by data sources 11-13 to generate business rules 22 that govern service delivery. For example, business rules 22 may be generated to provide customer service time objectives or define customer service offerings that vary by customer level or class (see, e.g., U.S. Patent Publication No. 20040087367).

Business rules 22 are then used within utilization and prioritization layer 30 to drive a plurality of service applications 31-34. Typical service applications may include, for example, resource allocation, service opportunity identification and dispatch, and service recovery (i.e., additional service offers or actions taken in the event of a failure to meet service objectives and/or customer requirements), as well as a variety of other service applications used for service provisioning and delivery. As service resources typically tend to be limited in number according to specific capabilities and qualifications and associated expense or cost, service applications 31-34 in the utilization and prioritization layer 30 will be directed to applying service resources among competing service demands and opportunities in an optimal fashion by applying the business rules.

An optimization and forecasting layer 40 provides means for evaluating and adjusting the service applications 31-34 operating in the utilization and prioritization layer 30 in real-time in order to achieve optimal performance. In particular, analysis and simulation engine 42 assembles the output of service applications 31-34 together with service data 41 indicative of service performance (for example, scores from customer satisfaction surveys as an indicator of potential profitability of service), as well as historical data indicative of service capacity and service demand, in order to simulate and predict future service performance. Importantly, profitability analysis module 43 is employed to model and evaluate immediate and longer term impact of service levels on service costs, profitability, and other business benefits. Results from this analysis are fed back to the data processing layer 20 in order to be processed by server 21 for adjusting business rules 22, and thereafter adjusting service delivery in real-time via service applications 31-34, including resource allocations.

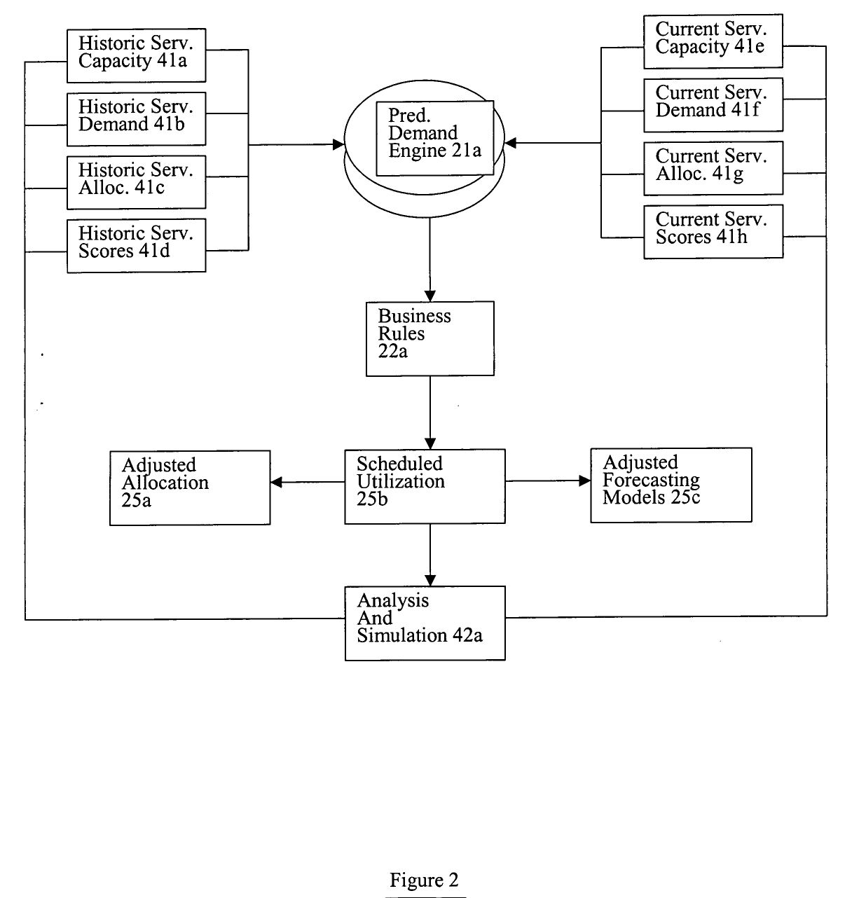

FIG. 2 presents some additional detail relating to the components of the optimization and forecasting layer 40 illustrated in FIG. 1. In FIG. 2, predictive demand engine 21a operates on historical and real-time information 41a-41h relating to service capacity (i.e., resources generally available for service delivery) and associated costs, service demand (i.e., collection of service activities desired and/ore requested by customers), service allocation (i.e., assignment of service delivery resources to spatial locations supporting service delivery, and to specific service activities and/or customer levels), and service performance. Service performance measures may include objective measures (such as time to respond to a customer request) as well as subjective measures (such as customer report card scores). Based on this information, predictive demand engine 21a determines defacto business rules 22a.

Based on the defacto rules 22a, a scheduled utilization of resources is produced, which accounts for the impact of events identified in the real-time data. For example, based on real-time data, scheduled utilization may attribute a drop in available service capacity to a decline in available staff over a holiday period. As a result of changes resulting from real-time events, allocated resources 25a are adjusted (for example, redirecting resources to spatial sites experiencing a severe service capacity drop), and forecasting models 25c are adjusted to reflect current and improved information.

With information relating to historical and real-time events, service delivery performance can be simulated in a manner that accounts for both random and non-random variation in demand, resource capacity, resource allocation and service delivery scoring (for example, using Monte Carlo simulation and/or other well-known simulation tools and techniques). Simulation results are added to the historical data and used by predictive demand engine 21a to further hone forecasting models. Simulation results can also be added to current data 41e-41h in order to influence business rules set for the current state.

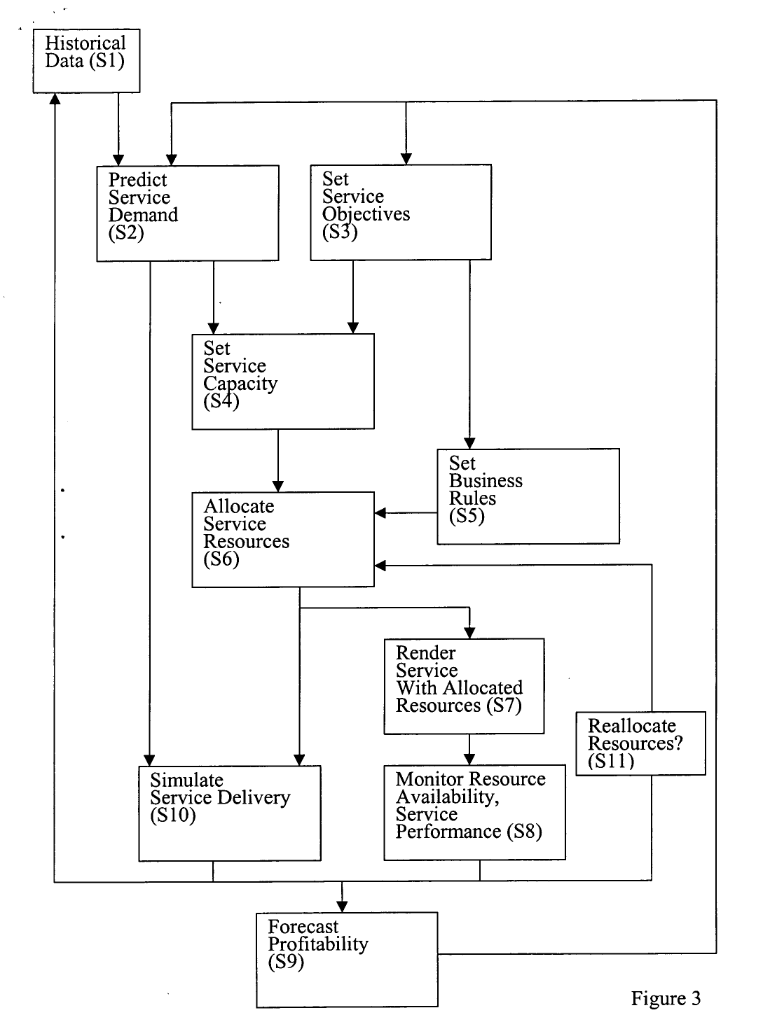

FIG. 3 presents a flow diagram illustrating a series of steps associated with a method according to the present invention. First, historical data is collected at step S1. At step S2, service demand is predicted, and service objectives are determined at step S3 as a result of analyzing customer service scores and historical service objectives and rules. Once service demand is predicted and service objectives are set, a desired service capacity is determined at step S4. Desired service capacity may be adjusted, for example, in relation to current service capacity (i.e., there may be practical limits, for example, on the amount of growth that can be realized over current service capacity in order to reach a higher desired level).

At step S5, business rules are established in relation to service objectives. On the basis of service capacity and business rules, resources are allocated at step S6 (for example, by spatial site, service event type and customer level), and are then monitored and re-allocated. Once business rules are established and resources are allocated, services can be rendered at step S7. Actual resource availability and performance of rendered services are monitored at step S8, and profitability from actual performance is forecast at step S9. For example, profitability may be forecast by determining or predicting:
a cost of resources provided;
services delivered at a level at or in excess of desired service objectives, and a forecast profit from these services based on customer potential value and the value from moving old inventory out to open up space for new products coming in; and
services delivered against anticipated service demand at a level below desired services objectives, and an forecast cost of poor service based on customer potential value lost, less the value from moving old inventory out to open up space for new products coming in.

In addition or alternatively, service delivery is simulated at step S10 using Monte Carlo or other known simulation techniques, and simulation results are produced for use in the profitability forecast at step S9. Results of the profitability forecast may then be used to adjust predicted demand and service objectives at steps S2, S3 and to begin another cycle. In addition, based on actual resource availability and service performance results, a decision can be made to reallocate resources in real time, for example, to adjust for unexpected service events and the like.

The foregoing describes the invention in terms of embodiments foreseen by the inventor for which an enabling description was available, notwithstanding that insubstantial modifications of the invention, not presently foreseen, may nonetheless represent equivalents thereto.

1. A method for allocating resources for delivery of a customer service, the method comprising the steps of:
a) forecasting an anticipated service demand for the customer service;
b) forecasting available resources for service delivery
c) setting desired service objectives for delivery of the customer service to each of one or more customer classes;
d) setting a service capacity according to the anticipated service demand, the desired service objectives and the available resources;
e) setting business rules for service delivery based on the desired service objectives for the one or more customer classes;
f) allocating the available resources based on the service capacity and business rules;
g) monitoring actual service demand, resource availability and service delivery performance against the desired service objectives;
h) forecasting a measure of profitability of service delivery based on the monitored service demand, resource availability and service delivery performance;
i) adjusting the desired service objectives in real-time to maximize the measure of profitability of service delivery;
j) repeating steps a)-f) in real-time based on the adjusted service objectives, the monitored service demand and the monitored resource availability.

2. The method of claim 1, wherein the anticipated service demand and available resources are forecast based on historical data.

3. The method of claim 2, wherein the anticipated service demand and available resources are forecast by means of statistical models.

4. The method of claim 1, wherein the anticipated service demand is forecast for each of a plurality of spatial service locations, service capacities are set for each of the plurality of spatial service locations, and available resources are allocated among the plurality of spatial service locations as a function of the service capacities.

5. The method of claim 1, wherein the anticipated service demand is forecast for each of the one or more customer classes.

6. The method of claim 1, wherein allocated resources include at least one of labor, equipment, products, literature, materials, customer goodwill and time.

7. The method of claim 1, wherein the anticipated service demand is forecast as a function of required service delivery skill sets, and the available resources are classified and allocated according to associated service delivery skill sets.

8. A system architecture for allocating resources for delivering customer service, the architecture comprising:
a data collection layer for collecting information from one or more data sources relating to at least one of a cost of resources for delivering services, a historical service demand, a current resource capacity, and measures of historical service delivery performance;
a data processing layer for processing the information provided by the one or more data sources to produce a set of business rules for service delivery, the business rules including service delivery objectives;
a utilization and prioritization layer for operating one or more service applications according to the business rules, including at least one service application for allocating resources for service delivery; and
an optimization and forecasting layer for evaluating service delivery performance in real-time to forecast service delivery profitability, wherein service delivery profitability is predicted as a function of a cost of allocated resources, a predicted profit based on customer value for services delivered at or above the service delivery objectives, and a predicted cost based on customer value for services delivered below the service delivery objectives.

9. The system architecture according to claim 8, wherein;
the optimization and forecasting layer forecasts future service demand and future resource availability and predicts an optimal allocation of forecast resources for maximizing service delivery profitability.

10. The system architecture according to claim 9, wherein:
forecast information from the optimization and forecasting layer is provided to the data processing layer in real-time for adjusting the business rules.

11. The system architecture according to claim 9, wherein:
the optimization and forecasting layer simulates future service demand, future resource availability and future service delivery performance to predict the optimal allocation of forecast resources for maximizing service delivery profitability.
